(19) United States
(12) Patent Application Publication
(10) Pub. No.: US 2009/0090808 A1
(43) Pub. Date: Apr. 9, 2009

(54) Flushable toilet paper roll center

(76) Inventors: Nathan K. Lawrence, Indianapolis, IN (US); Romon O. Lawrence, Indianapolis, IN (US)

Correspondence Address: JAMES RAY & ASSOCIATES, 2640 PITCAIRN ROAD, MONROEVILLE, PA, 15146, US

(21) Appl. No.: 12/286,452

(22) Filed: Sep. 30, 2008

Related U.S. Application Data
(60) Provisional application No. 60/997,697, filed on Oct. 4, 2007.

(51) Int. Cl. B65H 75/18; B31C 11/06

(52) U.S. Cl. 242/610; 493/274

(57) ABSTRACT

A method of producing a roll center for one of toilet paper and paper towels that is water soluble. The method comprises the steps of selecting a rod that has the diameter of a traditional toilet paper roll center followed by a step of wrapping a water dissolvable material around the rod. There is a step of drying the material for a predetermined time, such predetermined time being sufficient for such material to become firm and a step of placing toilet paper around the material as is done with traditional roll centers.

### CROSS REFERENCE TO RELATED APPLICATIONS

This application is closely related to and claims benefit from U.S. Provisional Application Ser. No. 60/997,697 filed Oct. 4, 2007.

### FIELD OF THE INVENTION

The present invention relates, in general, to a toilet paper roll, and, more particularly, the present invention relates to a toilet paper roll in which the center of the roll is flushable.

### BACKGROUND OF THE INVENTION

Traditional toilet paper roll centers can create unneeded trash for the user. They can take up space in a bathroom's wastebasket making the room look unkempt. Further, the cardboard centers that are presently in use create one more item that can pollute the environment when they are simply thrown out with the trash and put into landfills.

Thus, it would be advantageous if there were a roll center for toilet paper that could be disposed of by flushing down the toilet and not disposed of by simply throwing it out with the trash.

### SUMMARY OF THE INVENTION

In a first aspect the present invention provides a method of producing a roll center for one of toilet paper and paper towels that is water soluble. The method comprises the steps of selecting a rod that has the diameter of a traditional toilet paper roll center followed by a step of wrapping a water dissolvable material around the rod. There is a step of drying the material for a predetermined time, such predetermined time being sufficient for such material to become firm and a step of placing toilet paper around said material as is done with traditional roll centers.

In a second aspect the present invention provides a toilet paper roll center that is made according to the method described previously.

### OBJECTS OF THE INVENTION

It is, therefore, one of the primary objects of the present invention to provide a roll center that can be disposed of by flushing it down the toilet.

Another object of the present invention is to provide a roll center for toilet paper that is dissolvable in water.

Still another object of the present invention is to provide a roll center for toilet paper that is easily produced.

Yet another object of the present invention is to provide a roll center for toilet paper that is relatively inexpensive to produce.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a side perspective view of a prior art roll of toilet paper having a traditional cardboard type roll center.

FIG. 2 is a side perspective view of a prior art roll center that is traditionally made of cardboard.

FIG. 3 is a side perspective view of a water dissolvable roll center according to an embodiment of the invention.

FIG. 4 is a perspective view of the roll center according to the present invention being disposed into a toilet.

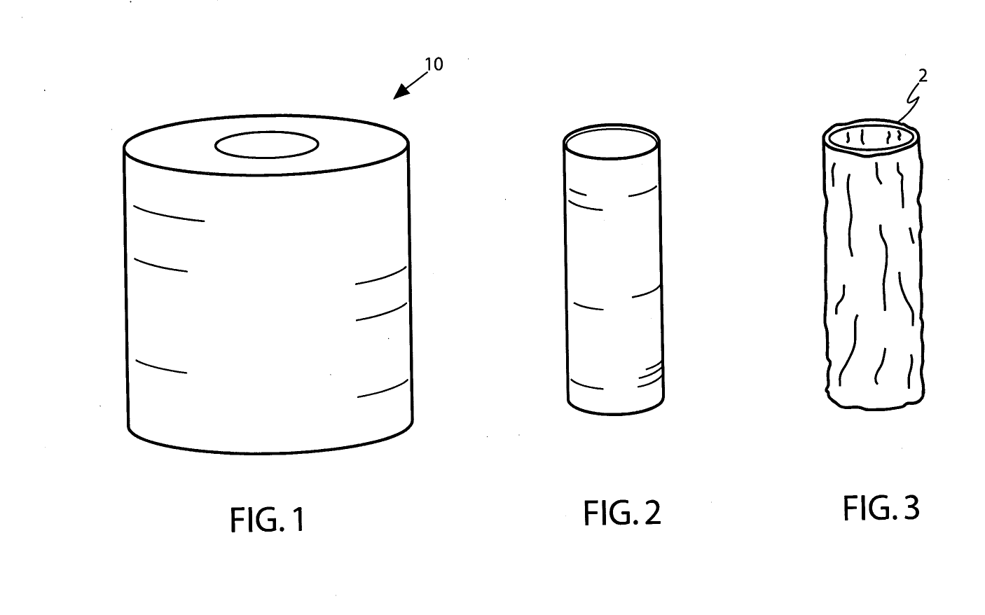

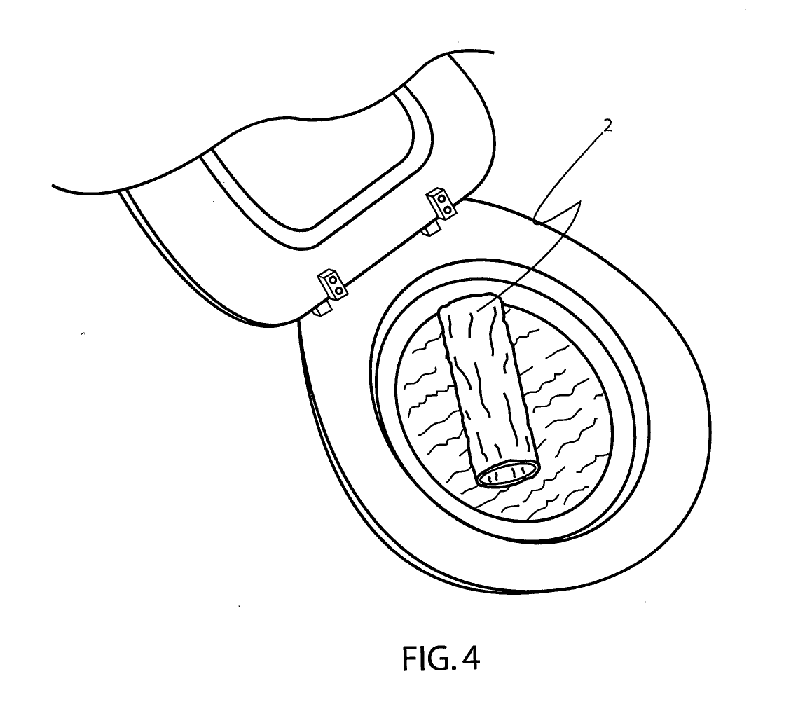

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides a method of producing a roll center 2 for one of toilet paper 10 and paper towels that is water soluble. The method comprises the steps of selecting a rod that has the diameter of a traditional toilet paper roll center followed by a step of wrapping a water dissolvable material around the rod. There is a step of drying the material for a predetermined time, such predetermined time being sufficient for such material 2 to become firm and a step of placing toilet paper 10 around the material 2 as is done with traditional roll centers.

The method further includes a step of pre-drying the material 2 after the material has been wrapped around such rod. The method further includes the step of baking such material 2 in the drying step to ensure that such material 2 becomes firm in a shorter period of time. The method further includes the step of selecting a rod that has a diameter of between about 1⅝ inches and 1⅞ inches.

In a second aspect the present invention provides a toilet paper roll center that is made according to the method described previously. Such toilet paper roll center 2 is flushable in a toilet since such roll center is made of soluble paper so that disposal of such roll center is eco-friendly.

The toilet paper roll center 2 is between about 4 and ⅜ inches and about 4⅝ inches long. And such roll center 2 has diameter of between about 1⅝ and about 1⅞ inches.

Thus, the present invention provides a roll center for toilet paper that can be flushed down the toilet thereby leaving the user with no trash to dispose of. The product is approximately 4½ inches long with a diameter of about 1¾ inches similar to presently used cardboard roll centers. The roll center is made by wrapping a water dissolvable paper around a thick rod and permitting the paper to dry. Once the material is wrapped around the rod it is then dried again or baked till the paper becomes firm. Toilet paper is then placed around the roll center in the same fashion as is done with the traditional toilet paper roll centers.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. A method of producing a roll center for toilet paper that is water dissolvable, said method comprises the steps of;
(a) selecting a rod that has a diameter of a traditional toilet paper roll center;
(b) wrapping a water dissolvable material around said rod;
(c) drying said material for a predetermined time, said predetermined time being sufficient for said material to become firm and
(d) placing toilet paper around said material as is done with traditional roll centers.

2. The method, according to claim 1, wherein said method further includes the step of pre-drying said material after step (b).

3. The method, according to claim 1, wherein said method further includes the step of baking said material in step (c).

4. The method, according to claim 1, wherein said method further includes the step of selecting a rod that has a diameter of between about 1⅝ inches and 1⅞ inches.

5. A toilet paper roll center made according to the method described in claim 1.

6. The toilet paper roll center, according to claim 10, wherein said roll center is flushable in a toilet.

7. The toilet paper roll center, according to claim 5, wherein said roll center is between about 4 and ⅜ inches and about 4⅝ inches long.

8. The toilet paper roll center, according to claim 5, wherein said roll center has diameter of between about 1⅝ and about 1⅞ inches.
